(19) United States
(12) Patent Application Publication
(10) Pub. No.: US 2014/0104873 A1
(43) Pub. Date: Apr. 17, 2014

(54) BACKLIGHT MODULE

(71) Applicants: Gang Yu, Shenzhen City (CN); Yubo Gu, Shenzhen City (CN); Liuyang Yang, Shenzhen City (CN)

(72) Inventors: Gang Yu, Shenzhen City (CN); Yubo Gu, Shenzhen City (CN); Liuyang Yang, Shenzhen City (CN)

(73) Assignee: Shenzhen China Star Optoelectroncs Technology Co., Ltd., Shenzhen, Guangdong (CN)

(21) Appl. No.: 13/806,798

(22) PCT Filed: Oct. 26, 2012
(86) PCT No.: PCT/CN2012/083528

§ 371 Date: Dec. 24, 2012

(30) Foreign Application Priority Data
Oct. 12, 2012 (CN) 201210387289.8

(51) Int. Cl. F21V 8/00

(52) U.S. Cl. CPC G02B 6/0081; G02B 6/0036; G02B 6/0035
USPC 362/607; 362/611; 362/614

(57) ABSTRACT

The present invention provides a backlight module, which includes a backplane, a light source arranged inside the backplane, a reflector plate arranged inside the backplane, a light guide plate arranged on the reflector plate, and a mold frame mounted to the backplane, the backplane and the mold frame being coated with a layer of high reflectivity material at portions corresponding to the light source. The backlight module of the present invention uses a high reflectivity material layer coated on a backplane and a mold frame at the site of a light source that improve utilization rate of light and has a simple structure. Further, the amount of the high reflectivity material used is relatively small so as to effectively control the cost. The backplane and the mold frame are coupled to each other through snap fitting so that assembling/disassembling is easy and a large amount of time can be saved.

### BACKGROUND OF THE INVENTION

1. Field of the Invention

The present invention relates to the field of liquid crystal displaying, and in particular to a backlight module.

2. The Related Arts

Liquid crystal display (LCD) has a variety of advantages, such as thin device body, low power consumption, and being free of radiation, and is thus widely used. Most of the LCDs that are currently available in the market are backlighting LCDs, which comprise a liquid crystal panel and a backlight module. The operation principle of the liquid crystal panel is that liquid crystal molecules are interposed between two parallel glass substrates and a plurality of vertical and horizontal fine electrical wires are arranged between the two glass substrates, whereby the liquid crystal molecules are controlled to change direction by application of electricity in order to refract light emitting from the backlight module for generating images. Since the liquid crystal panel itself does not emit light, light must be provided by the backlight module in order to normally display images. Thus, the backlight module is one of the key components of an LCD. The backlight module can be classified in two types, namely side-edge backlight module and direct backlight module, according to the position where light gets incident. The direct backlight module comprises a light source, such as a cold cathode fluorescent lamp (CCFL) or a light-emitting diode (LED), which is arranged at the back side of the liquid crystal panel to form a planar light source that directly provides lighting to the liquid crystal panel. The side-edge backlight module comprises a backlight source of LED light bar arranged at an edge of a backplane to be located rearward of one side of the liquid crystal panel. The LED light bar emits light that enters a light guide plate (LGP) through a light incident face of the light guide plate and is projected out through a light emergence face of the light guide plate, after being reflected and diffused, to thereby transmit through an optic film assembly and form a planar light source for the liquid crystal panel.

As shown in FIG. 1, a schematic view is given to show a conventional liquid crystal display device. The liquid crystal display device comprises a front frame 100, a rear frame 300 mating the front frame 100, a liquid crystal display panel 500 arranged between the front frame 100 and the rear frame 300, and a backlight module 700 arranged between the front frame 100 and the rear frame 300 and located under the liquid crystal display panel 500. A light blocking unit 900 that is made of a black adhesive material is arranged between the liquid crystal display panel 500 and the backlight module 700. The light blocking unit 900 is fixed to a diffusion board 702 of the backlight module 700 at a location adjacent to a non-display zone 502 of the liquid crystal display panel 500 to prevent leakage of light. However, it is a troublesome process of adhering the light blocking unit 900 to the diffusion board 502 and it often occurs that the light blocking unit 900 is incorrectly adhered, making a display zone 504 of the liquid crystal display panel 500 blocked by a portion of the light blocking unit 900 and leading to a problem of displaying for the liquid crystal display device.

A shown in FIG. 2, a schematic view is given to show the structure of a conventional backlight module 500′, which comprises a backplane 520′, a light source 504′ arranged inside the backplane 520′, a reflector plate 560′ arranged inside the backplane 520′, a light guide plate 580′ arranged above the reflector plate 560′, an optic film assembly 590′ arranged on the light guide plate 580′, and a mold frame 530′ mounted to the backplane 520′. The mold frame 530′ is made of polycarbonate that has a high reflectivity mixed with 10% titanium oxide. The backplane 520′ is made of polycarbonate. The mold frame 530′ shows both properties of light reflection and light blocking. The backplane 520′ has excellent light reflectivity so as to capable of overcoming light leakage issue of backlighting shown in FIG. 1 and thereby ensuring improved light utilization rate of backlighting. However, since the cost of polycarbonate having high reflectivity mixed with 10% titanium oxide is high, making it disadvantageous.

### SUMMARY OF THE INVENTION

An object of the present invention is to provide a backlight module, which has a simple structure and improved quality of backlighting, and is effective in controlling cost.

To achieve the object, the present invention provides a backlight module, which comprises a backplane, a light source arranged inside the backplane, a reflector plate arranged inside the backplane, a light guide plate arranged on the reflector plate, and a mold frame mounted to the backplane. The backplane and the mold frame are coated with a layer of high reflectivity material at portions corresponding to the light source.

The backplane comprises a bottom board and a first side board connected to the bottom board. The first side board forms a retention slot close to the bottom board.

The mold frame comprises a top board and a second side board connected to the top board. The second side board has a free end that forms a retention pawl corresponding to the retention slot. The pawl section is receivable in and retained by the retention slot so as to fix the backplane and the mold frame together.

The pawl section is formed to extend toward the top board in an inclined manner from an inside surface of the second side board at a free end thereof and has an inclined face. The inclined face is arranged to face toward the retention slot.

The light source is connected by an electrical wire to electrically connect to an external circuit.

The top board of the mold frame forms a receiving channel corresponding to the electrical wire and the electrical wire is received in the receiving channel.

The receiving channel has a side wall forming a barb for retaining the electrical wire in the receiving channel.

The backlight module further comprises a heat dissipation plate arranged under the reflector plate, a diffusion plate arranged on the light guide plate, and a prism plate arranged on the diffusion plate.

The backlight source comprises a linear CCFL light source.

The high reflectivity material layer is an aluminum powder layer.

The present invention also provides a backlight module, which comprises a backplane, a light source arranged inside the backplane, a reflector plate arranged inside the backplane, a light guide plate arranged on the reflector plate, and a mold frame mounted to the backplane, the backplane and the mold frame being coated with a layer of high reflectivity material at portions corresponding to the light source;

wherein the backplane comprises a bottom board and a first side board connected to the bottom board, the first side board forming a retention slot close to the bottom board;

wherein the mold frame comprises a top board and a second side board connected to the top board, the second side board having a free end that forms a retention pawl corresponding to the retention slot, the pawl section being receivable in and retained by the retention slot so as to fix the backplane and the mold frame together;

wherein the pawl section is formed to extend toward the top board in an inclined manner from an inside surface of the second side board at a free end thereof and has an inclined face, the inclined face being arranged to face toward the retention slot;

wherein the light source is connected by an electrical wire to electrically connect to an external circuit;

wherein the top board of the mold frame forms a receiving channel corresponding to the electrical wire and the electrical wire is received in the receiving channel;

wherein the receiving channel has a side wall forming a barb for retaining the electrical wire in the receiving channel;

further comprising a heat dissipation plate arranged under the reflector plate, a diffusion plate arranged on the light guide plate, and a prism plate arranged on the diffusion plate;

wherein the backlight source comprises a linear CCFL light source; and

wherein the high reflectivity material layer is an aluminum powder layer.

The efficacy of the present invention is that the present invention provides a backlight module, which comprises a high reflectivity material layer coated on a backplane and a mold frame at the site of a light source that improve utilization rate of light and has a simple structure. Further, amount of the high reflectivity material is relatively small so as to effectively control the cost. In addition, the backplane and the mold frame are coupled to each other through snap fitting so that assembling/disassembling is easy and a large amount of time can be saved to thereby improving manufacturing efficiency and reducing manufacturing cost.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, of the present invention will be apparent from the following detailed description of an embodiment of the present invention, with reference to the attached drawing. In the drawing:

FIG. 1 is a schematic view showing the structure of a conventional liquid crystal display device;

FIG. 2 is a schematic view showing the structure of a conventional backlight module; and

FIG. 3 is a schematic view showing the structure of a backlight module of the present invention.

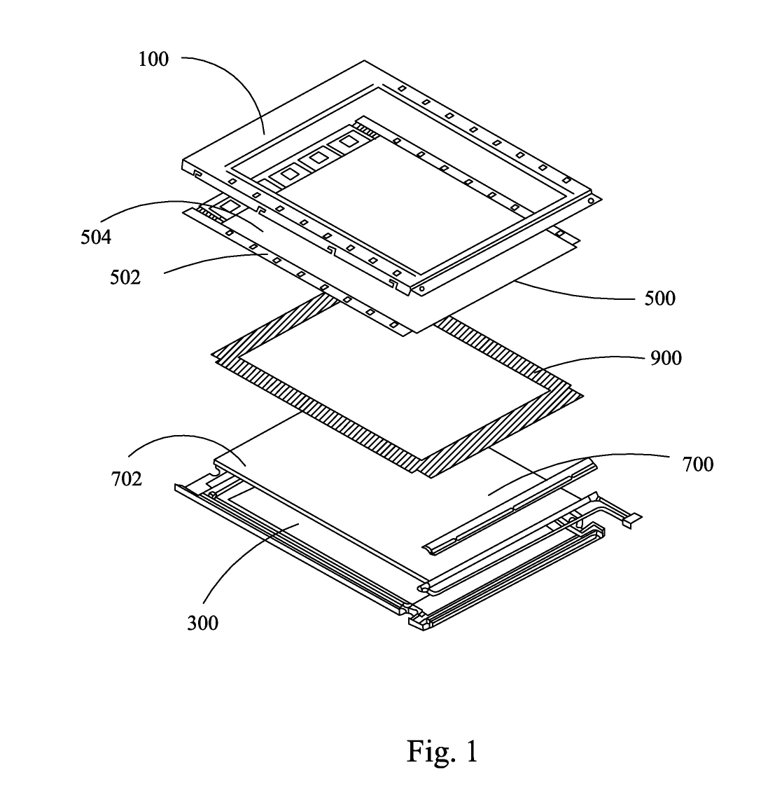

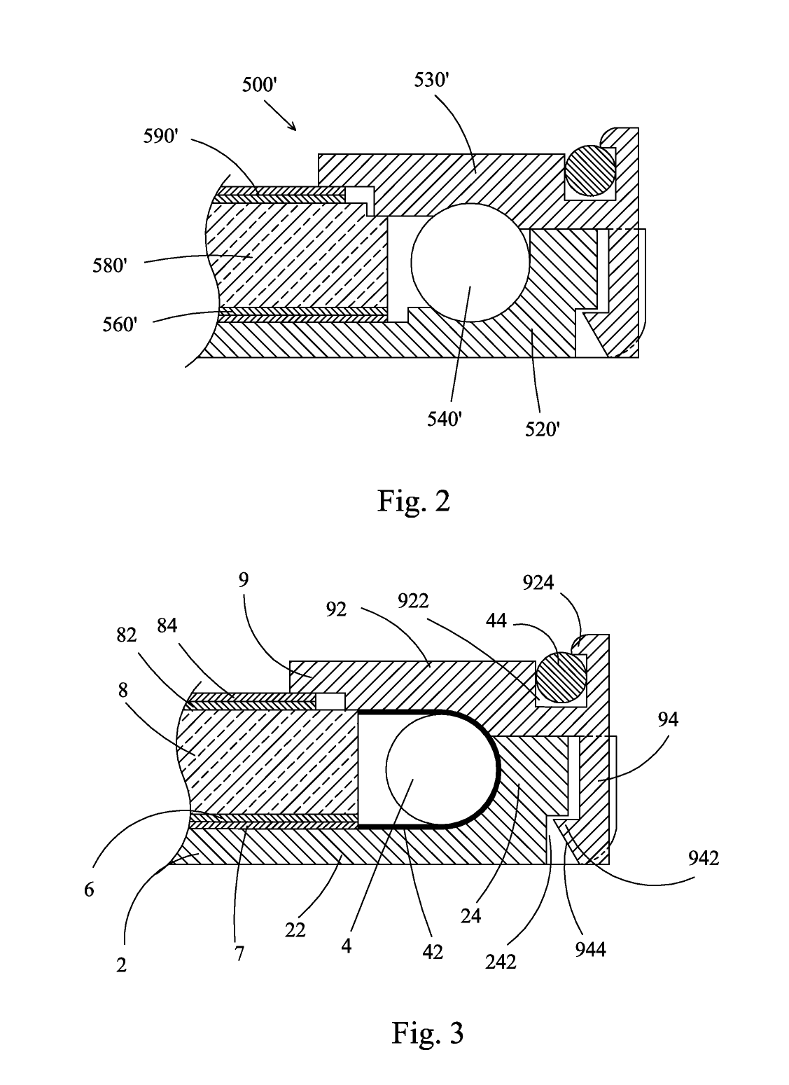

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

Referring to FIG. 3, the present invention provides a backlight module, which comprises a backplane 2, a light source 4 arranged inside the backplane 2, a reflector plate 6 arranged inside the backplane 2, a light guide plate 8 arranged on the reflector plate 6, and a mold frame 9 mounted to the backplane 2. The backplane 2 and the mold frame 9 are coated with a layer of high reflectivity material 42 at portions corresponding to the light source 4. The high reflectivity material layer 42 reflects the light emitting from the light source 4 to make more light entering the light guide plate 8 for improving light utilization rate. In the instant embodiment, the high reflectivity material is aluminum powder and the high reflectivity material layer 42 is an aluminum powder layer.

The backplane 2 comprises a bottom board 22 and a first side board 24 that is connected to the bottom board 22. The first side board 24 forms a retention slot 242 close to the bottom board 22. The mold frame 9 comprises a top board 92 and a second side board 94 connected to the top board 92. The second side board 94 has a free end that forms a retention pawl 942 corresponding to the retention slot 242. The pawl section 942 is received in and retained by the retention slot 242 so as to fix the backplane 2 and the mold frame 9 together. In the instant embodiment, the pawl section 942 is formed to extend toward the top board 92 in an inclined manner from an inside surface of the second side board 94 at a free end thereof and has an inclined face 944. The inclined face 944 is arranged to face toward the retention slot 242.

To assemble, the mold frame 9 is positioned on the backplane 2 and is directly pressed down to have the inclined face 944 subjected to an outward action force, which make the second side board 94 deflecting outward until the pawl section 942 receiving in and engaging the retention slot 242 to assemble the backplane 2 and the mold frame 9 together. To disassemble, an outward force is applied to the inclined face 944 to cause the second side board 94 to deflect outward to allow the pawl section 942 to slide off the retention slot 222 thereby separating the mold frame 50 and the backplane 10 from each other. And, at the same time, an upward force is applied to have the mold frame 9 and the backplane 2 separating from each other. The processing of disassembling is simple and time can be saved, whereby manufacturing efficiency is improved and manufacturing cost is reduced.

The light source 4 is connected by an electrical wire 44 to electrically connect to an external circuit (not shown) to supply electrical power to the light source 4 for making the light source 4 emitting light.

The top board 92 of the mold frame 9 forms a receiving channel 922 corresponding to the electrical wire 44 and the electrical wire 44 is received in the receiving channel 922. Preferably, the receiving channel 922 has a side wall forming a barb 924 for retaining the electrical wire 44 in the receiving channel 922.

The backlight module according to the present invention also comprises a heat dissipation plate 7 arranged under the reflector plate 6, a diffusion plate 82 arranged on the light guide plate 8, and a prism plate 84 arranged on the diffusion plate 82. The light source 4 comprises a linear CCFL (Cold Cathode Fluorescent Lamp) light source, which emits light of which a portion directly transmits through an incidence surface of the light guide plate 8 to enter the interior of the light guide plate 8 and a remaining portion is reflected by the reflector plate 7 to get into the light guide plate 8. The light propagates through the light guide plate 8 as being simultaneously subjected to total reflection and refraction and is further subjected to diffusion through the diffusion plate 82 and the prism plate 84 to thereby provide a uniformly distributed planar light source.

In summary, the present invention provides a backlight module, which comprises a high reflectivity material layer coated on a backplane and a mold frame at the site of a light source that improve utilization rate of light and has a simple structure. Further, amount of the high reflectivity material is relatively small so as to effectively control the cost. In addition, the backplane and the mold frame are coupled to each other through snap fitting so that assembling/disassembling is easy and a large amount of time can be saved to thereby improving manufacturing efficiency and reducing manufacturing cost.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A backlight module, comprising a backplane, a light source arranged inside the backplane, a reflector plate arranged inside the backplane, a light guide plate arranged on the reflector plate, and a mold frame mounted to the backplane, the backplane and the mold frame being coated with a layer of high reflectivity material at portions corresponding to the light source.

2. The backlight module as claimed in claim 1, wherein the backplane comprises a bottom board and a first side board connected to the bottom board, the first side board forming a retention slot close to the bottom board.

3. The backlight module as claimed in claim 2, wherein the mold frame comprises a top board and a second side board connected to the top board, the second side board having a free end that forms a retention pawl corresponding to the retention slot, the pawl section being receivable in and retained by the retention slot so as to fix the backplane and the mold frame together.

4. The backlight module as claimed in claim 3, wherein the pawl section is formed to extend toward the top board in an inclined manner from an inside surface of the second side board at a free end thereof and has an inclined face, the inclined face being arranged to face toward the retention slot.

5. The backlight module as claimed in claim 3, wherein the light source is connected by an electrical wire to electrically connect to an external circuit.

6. The backlight module as claimed in claim 5, wherein the top board of the mold frame forms a receiving channel corresponding to the electrical wire and the electrical wire is received in the receiving channel.

7. The backlight module as claimed in claim 6, wherein the receiving channel has a side wall forming a barb for retaining the electrical wire in the receiving channel.

8. The backlight module as claimed in claim 1 further comprising a heat dissipation plate arranged under the reflector plate, a diffusion plate arranged on the light guide plate, and a prism plate arranged on the diffusion plate.

9. The backlight module as claimed in claim 1, wherein the backlight source comprises a linear CCFL light source.

10. The backlight module as claimed in claim 1, wherein the high reflectivity material layer is an aluminum powder layer.

11. A backlight module, comprising a backplane, a light source arranged inside the backplane, a reflector plate arranged inside the backplane, a light guide plate arranged on the reflector plate, and a mold frame mounted to the backplane, the backplane and the mold frame being coated with a layer of high reflectivity material at portions corresponding to the light source;
wherein the backplane comprises a bottom board and a first side board connected to the bottom board, the first side board forming a retention slot close to the bottom board;
wherein the mold frame comprises a top board and a second side board connected to the top board, the second side board having a free end that forms a retention pawl corresponding to the retention slot, the pawl section being receivable in and retained by the retention slot so as to fix the backplane and the mold frame together;
wherein the pawl section is formed to extend toward the top board in an inclined manner from an inside surface of the second side board at a free end thereof and has an inclined face, the inclined face being arranged to face toward the retention slot;
wherein the light source is connected by an electrical wire to electrically connect to an external circuit;
wherein the top board of the mold frame forms a receiving channel corresponding to the electrical wire and the electrical wire is received in the receiving channel;
wherein the receiving channel has a side wall forming a barb for retaining the electrical wire in the receiving channel;
further comprising a heat dissipation plate arranged under the reflector plate, a diffusion plate arranged on the light guide plate, and a prism plate arranged on the diffusion plate;
wherein the backlight source comprises a linear CCFL light source; and
wherein the high reflectivity material layer is an aluminum powder layer.
